(19) United States
(12) Patent Application Publication
(10) Pub. No.: US 2025/0257990 A1
(43) Pub. Date: Aug. 14, 2025

(54) PATH LENGTH MATCHING ARMS OF AN INTERFEROMETER

(71) Applicant: Quantinuum LLC, Broomfield, CO (US)

(72) Inventors: Bruce Gregory Tiemann, Longmont, CO (US); John Peter HOULTON, Broomfield, CO (US); Matthew J. BOHN, Broomfield, CO (US)

(21) Appl. No.: 19/020,342

(22) Filed: Jan. 14, 2025

Related U.S. Application Data
(60) Provisional application No. 63/553,317, filed on Feb. 14, 2024.

(51) Int. Cl. G01B 9/02055; G01B 9/02056

(52) U.S. Cl. CPC G01B 9/02072; G01B 9/02058

(57) ABSTRACT

A length of signal guide is connected to a first arm of an interferometer. Respective first phase noise measurements of the phase noise of a combined signal formed by combining respective signals propagated along the first arm and the second arm are determined at a plurality of frequencies while the length of signal guide is connected to the first arm. Based at least in part on the first phase noise measurements, a path length difference between the first and second arms is determined. A length of the first arm or the second arm is adjusted based at least in part on the path length difference.

### CROSS-REFERENCE TO RELATED APPLICATION(S)

This application claims priority to U.S. Application No. 63/553,317, filed Feb. 14, 2024, the content of which is incorporated herein by reference in its entirety.

### TECHNICAL FIELD

Various embodiments relate to the path length matching of arms of an interferometer. For example, various embodiments relate to a method for path length matching arms of an interferometer, which may be an optical interferometer or an electrical interferometer.

### BACKGROUND

In various scenarios, optical or electrical signals may be modified by an interferometer. Generally, an interferometer includes two arms and the output of those two arms are combined to form an interference pattern or signal. When the length of the two arms is not exactly the same, the respective linewidths of the optical or electrical signals can result in undesired phase noise or amplitude response in the interference signal. This undesired response may result in technical problems in the system employing the interferometer in various applications. Through applied effort, ingenuity, and innovation many deficiencies of such systems have been solved by developing solutions that are structured in accordance with the embodiments of the present invention, many examples of which are described in detail herein.

### BRIEF SUMMARY OF EXAMPLE EMBODIMENTS

Example embodiments provide methods for path length matching arms of an interferometer, apparatuses configured to perform such methods, computer program products configured to cause apparatuses to perform such methods, and/or the like. In various embodiments, the method includes measuring the phase noise between the two arms of the interferometer when the lengths of the arms are modified in a known manner.

For example, a length of signal guide is added to a first arm of the interferometer and the respective first phase noise measurements between the first and second arms are captured and/or determined at a plurality or a sweep of signal frequencies. The length of signal guide is then removed from the first arm and added to the second arm of the interferometer. The respective second phase noise measurements between the first and second arms are then measured at the plurality or sweep of signal frequencies. One or more first phase noise minimum frequencies corresponding to respective minimums or nulls in the respective first phase noise measurements are identified and one or more second phase noise minimum frequencies corresponding to respective minimums or nulls in the respective second phase noise measurements are identified. The one or more first phase noise minimum frequencies and the one or more second phase noise minimum frequencies are used to determine a path length difference between the first arm and the second arm. The length of the first arm and/or the second arm may be modified based on the determined path length difference.

According to one aspect, a computer-implemented method for determining and providing a path length difference between a first arm and a second arm of an interferometer is provided. In an example embodiment, the method is performed by a computing entity. In an example embodiment, the method comprises receiving first phase noise measurements, wherein the first phase noise measurements are respective measurements of phase noise between a first arm and a second arm of an interferometer for a plurality of signal frequencies when an additional length of signal guide is operationally coupled to the first arm; identifying a first phase noise minimum frequency based on the first phase noise measurements; determining a path length difference based at least in part on the first phase noise minimum frequency; and providing the path length difference.

In an example embodiment, the method further includes receiving second phase noise measurements, wherein the second phase noise measurements are respective measurements of phase noise between the first arm and the second arm of an interferometer for the plurality of signal frequencies when the additional length of signal guide is operationally coupled to the second arm; identifying a second phase noise minimum frequency based on the second phase noise measurements, wherein the path length difference is determined based at least in part on the first phase noise minimum frequency and the second phase noise minimum frequency.

In an example embodiment, the first phase noise measurements and the second phase noise measurements were captured by a phase noise analyzer measurement system.

In an example embodiment, the additional length of signal guide is one of an optical fiber, coaxial cable, or microwave waveguide.

In an example embodiment, identifying the first phase noise minimum frequency comprises identifying two or more minimums in the first phase noise measurements and determining the first phase noise minimum frequency based on respective frequencies corresponding to the two or more minimums in the first phase noise measurements and identifying the second phase noise minimum frequency comprises identifying two or more minimums in the second phase noise measurements and determining the second phase noise minimum frequency based on respective frequencies corresponding to the two or more minimums in the second phase noise measurements.

In an example embodiment, the first phase noise minimum frequency is determined based on the two or more minimums in the first phase noise measurements being harmonics of the first phase noise minimum frequency and the second phase noise minimum frequency is determined based on the two or more minimums of the second phase noise measurements being harmonics of the second phase noise minimum frequency.

In an example embodiment, identifying the first phase noise minimum frequency comprises identifying a respective frequencies corresponding to a first plurality of minimums in the first phase noise measurements, identifying the second phase noise minimum frequency comprises identifying a respective frequencies corresponding to a second plurality of minimums in the second phase noise measurements, and determining an path length difference comprises determining a plurality of path length differences based on pairs of frequencies including a first frequency corresponding to one of the first plurality of minimums and a second frequency corresponding to one of the second plurality of minimums and determining the path length difference based on the plurality of path length differences.

In an example embodiment, providing the path length difference comprises indicating a balancing length of signal guide and to which of the first arm or the second arm the balancing length of signal guide should be added to balance respective arm lengths of the first arm and the second arm.

In an example embodiment, the interferometer is configured to modulate one of optical signals or electrical signals.

In an example embodiment, the path length difference is determined based at least in part on the first phase noise minimum frequency and a known optical length of the additional length of signal guide.

In an example embodiment, an input signal provided to the interferometer to, at least in part, cause the respective first phase noise measurements to be determined contains one or more frequency components that may be swept over a frequency range of interest.

In an example embodiment, an input signal provided to the interferometer to, at least in part, cause the respective first phase noise measurements to be determined contains a plurality of frequency components that cover a frequency range of interest.

According to another aspect a method for path-length-matching arms of an interferometer is provided. In an example embodiment, the method includes operatively connecting a length of signal guide to a first arm of an interferometer. The interferometer includes the first arm and a second arm. The method further includes causing determination of respective first phase noise measurements between the first arm and the second arm at a plurality of frequencies while the length of signal guide is operatively connected to the first arm; removing the length of signal guide from the first arm of the interferometer; and based at least in part on the respective first phase noise measurements, causing a determination of an path length difference between the first arm and the second arm. The method further includes adjusting a length of the first arm or adjusting a length of the second arm based at least in part on the path length difference.

In an example embodiment, the method further includes operatively connecting the length of signal guide to the second arm of the interferometer; and causing determination of respective second phase noise measurements between the first arm and the second arm at a plurality of frequencies while the length of signal guide is operatively connected to the second arm, wherein determination of the path length difference is performed based at least in part on the respective first phase noise measurements and the respective second phase noise measurements.

In an example embodiment, the first phase noise measurements and the second phase noise measurements were captured by a phase noise analyzer measurement system.

In an example embodiment, the additional length of signal guide has a length such that a time required for light to propagate along the length of the additional length of signal guide is more than a reciprocal of a bandwidth of the phase noise analyzer.

In an example embodiment, the additional length of signal guide is one of an optical fiber, coaxial cable, or microwave waveguide.

In an example embodiment, identifying the first phase noise minimum frequency comprises identifying two or more minimums in the first phase noise measurements and determining the first phase noise minimum frequency based on respective frequencies corresponding to the two or more minimums in the first phase noise measurements and identifying the second phase noise minimum frequency comprises identifying two or more minimums in the second phase noise measurements and determining the second phase noise minimum frequency based on respective frequencies corresponding to the two or more minimums in the second phase noise measurements.

In an example embodiment, the first phase noise minimum frequency is determined based on the two or more minimums in the first phase noise measurements being harmonics of the first phase noise minimum frequency and the second phase noise minimum frequency is determined based on the two or more minimums of the second phase noise measurements being harmonics of the second phase noise minimum frequency.

In an example embodiment, identifying the first phase noise minimum frequency comprises identifying a respective frequencies corresponding to a first plurality of minimums in the first phase noise measurements, identifying the second phase noise minimum frequency comprises identifying a respective frequencies corresponding to a second plurality of minimums in the second phase noise measurements, and determining an path length difference comprises determining a plurality of path length differences based on pairs of frequencies including a first frequency corresponding to one of the first plurality of minimums and a second frequency corresponding to one of the second plurality of minimums and determining the path length difference based on the plurality of path length differences.

In an example embodiment, adjusting a length of the first arm or adjusting a length of the second arm based at least in part on the path length difference comprises one of (a) adding a signal guide having a length determined based on the path length difference to a shorter of the first arm and the second arm or (b) removing a portion of the longer of the first arm and the second arm having a length determined based on the path length difference.

In an example embodiment, adjusting a length of the first arm or adjusting a length of the second arm based at least in part on the path length difference causes the first arm and the second arm to have substantially the same path length.

In an example embodiment, an input signal provided to the interferometer to, at least in part, cause the respective first phase noise measurements to be determined contains one or more frequency components that may be swept over a frequency range of interest.

In an example embodiment, an input signal provided to the interferometer to, at least in part, cause the respective first phase noise measurements to be determined contains a plurality of frequency components that cover a frequency range of interest.

In another aspect, a computing entity configured to perform the computer-implemented method for determining and providing a path length difference between a first arm and a second arm of an interferometer is provided. In an example embodiment, the computing entity includes a processing device and memory storing computer executable instructions. The memory and the computer executable instructions configured to cause the processing device, when the processing device executes the computer executable instructions, to at least perform receiving first phase noise measurements, wherein the first phase noise measurements are respective measurements of phase noise between a first arm and a second arm of an interferometer for a plurality of signal frequencies when an additional length of signal guide is operationally coupled to the first arm; identifying a first phase noise minimum frequency based on the first phase noise measurements; receiving second phase noise measurements, wherein the second phase noise measurements are respective measurements of phase noise between the first arm and the second arm of an interferometer for the plurality of signal frequencies when the additional length of signal guide is operationally coupled to the second arm; identifying a second phase noise minimum frequency based on the second phase noise measurements; determining an path length difference based on the first phase noise minimum frequency and the second phase noise minimum frequency; and providing the path length difference.

In an example embodiment, the first phase noise measurements and the second phase noise measurements were captured by a phase noise analyzer measurement system.

In an example embodiment, the additional length of signal guide has a length such that a time required for light to propagate along the length of the additional length of signal guide is more than a reciprocal of a bandwidth of the phase noise analyzer.

In an example embodiment, the additional length of signal guide is one of an optical fiber, coaxial cable, or microwave waveguide.

In an example embodiment, identifying the first phase noise minimum frequency comprises identifying two or more minimums in the first phase noise measurements and determining the first phase noise minimum frequency based on respective frequencies corresponding to the two or more minimums in the first phase noise measurements and identifying the second phase noise minimum frequency comprises identifying two or more minimums in the second phase noise measurements and determining the second phase noise minimum frequency based on respective frequencies corresponding to the two or more minimums in the second phase noise measurements.

In an example embodiment, the first phase noise minimum frequency is determined based on the two or more minimums in the first phase noise measurements being harmonics of the first phase noise minimum frequency and the second phase noise minimum frequency is determined based on the two or more minimums of the second phase noise measurements being harmonics of the second phase noise minimum frequency.

In an example embodiment, identifying the first phase noise minimum frequency comprises identifying a respective frequencies corresponding to a first plurality of minimums in the first phase noise measurements, identifying the second phase noise minimum frequency comprises identifying a respective frequencies corresponding to a second plurality of minimums in the second phase noise measurements, and determining an path length difference comprises determining a plurality of path length differences based on pairs of frequencies including a first frequency corresponding to one of the first plurality of minimums and a second frequency corresponding to one of the second plurality of minimums and determining the path length difference based on the plurality of path length differences.

In an example embodiment, providing the path length difference comprises indicating a balancing length of signal guide and to which of the first arm or the second arm the balancing length of signal guide should be added to balance respective arm lengths of the first arm and the second arm.

In an example embodiment, the interferometer is configured to modulate one of optical signals or electrical signals.

In another aspect, a computer program product configured to cause a computing entity to perform the computer-implemented method for determining and providing a path length difference between a first arm and a second arm of an interferometer is provided. In an example embodiment, the computer program product includes at least one non-transitory storage medium storing computer executable instructions. The computer executable instructions include executable portions configured to, when executed by a processing device of a computing entity, cause the computing entity to perform receiving first phase noise measurements, wherein the first phase noise measurements are respective measurements of phase noise between a first arm and a second arm of an interferometer for a plurality of signal frequencies when an additional length of signal guide is operationally coupled to the first arm; identifying a first phase noise minimum frequency based on the first phase noise measurements; optionally receiving second phase noise measurements, wherein the second phase noise measurements are respective measurements of phase noise between the first arm and the second arm of an interferometer for the plurality of signal frequencies when the additional length of signal guide is operationally coupled to the second arm; optionally identifying a second phase noise minimum frequency based on the second phase noise measurements; determining a path length difference based at least in part on the first phase noise minimum frequency; and providing the path length difference.

In an example embodiment, the path length difference is determined based at least in part on the first phase noise minimum frequency and the second phase noise minimum frequency.

In an example embodiment, the path length difference is determined based at least in part on the first phase noise minimum frequency and a known optical length of the additional length of signal guide.

In an example embodiment, the first phase noise measurements and the second phase noise measurements were captured by a phase noise analyzer measurement system.

In an example embodiment, the additional length of signal guide has a length such that a time required for light to propagate along the length of the additional length of signal guide is more than a reciprocal of a bandwidth of the phase noise analyzer.

In an example embodiment, the additional length of signal guide is one of an optical fiber, coaxial cable, or microwave waveguide.

In an example embodiment, identifying the first phase noise minimum frequency comprises identifying two or more minimums in the first phase noise measurements and determining the first phase noise minimum frequency based on respective frequencies corresponding to the two or more minimums in the first phase noise measurements and identifying the second phase noise minimum frequency comprises identifying two or more minimums in the second phase noise measurements and determining the second phase noise minimum frequency based on respective frequencies corresponding to the two or more minimums in the second phase noise measurements.

In an example embodiment, the first phase noise minimum frequency is determined based on the two or more minimums in the first phase noise measurements being harmonics of the first phase noise minimum frequency and the second phase noise minimum frequency is determined based on the two or more minimums of the second phase noise measurements being harmonics of the second phase noise minimum frequency.

In an example embodiment, identifying the first phase noise minimum frequency comprises identifying a respective frequencies corresponding to a first plurality of minimums in the first phase noise measurements, identifying the second phase noise minimum frequency comprises identifying a respective frequencies corresponding to a second plurality of minimums in the second phase noise measurements, and determining an path length difference comprises determining a plurality of path length differences based on pairs of frequencies including a first frequency corresponding to one of the first plurality of minimums and a second frequency corresponding to one of the second plurality of minimums and determining the path length difference based on the plurality of path length differences.

In an example embodiment, providing the path length difference comprises indicating a balancing length of signal guide and to which of the first arm or the second arm the balancing length of signal guide should be added to balance respective arm lengths of the first arm and the second arm.

In an example embodiment, the interferometer is configured to modulate one of optical signals or electrical signals.

According to still another aspect, a system is provided. In an example embodiment, the system includes at least one interferometer comprising a first arm and a second arm where a path length of the first arm is substantially the same as a path length of the second arm as a result of the performance of a path-length-matching method.

In an example embodiment, the system is a QCCD-based quantum computer and the at least one interferometer is part of at least one of (a) a beam path system configured to provide a manipulation signal to a target location defined at least in part by a confinement apparatus of the QCCD-based quantum computer or (b) an electrical coupling between a voltage or current source and a potential generating element of the confinement apparatus.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system for use in path length matching arms of an interferometer, in accordance with an example embodiment.

FIG. 2 provides a schematic diagram of an interferometer including a first arm and a second arm, in accordance with an example embodiment.

FIG. 3A provides a flowchart illustrating various processes and/or procedures performed as part of a method to path length match arms of an interferometer, in accordance with an example embodiment.

FIG. 3B provides a schematic diagram of an interferometer during a first portion of the method to path length match arms of the interferometer, in accordance with an example embodiment.

FIG. 3C provides a schematic diagram of the interferometer during a second portion of the method to path length match arms of the interferometer, in accordance with an example embodiment.

FIG. 4 provides an example illustration of the first phase noise measurements at a plurality or sweep of frequencies and of the second phase noise measurements at the plurality or sweep of frequencies, in accordance with an example embodiment.

FIG. 5 provides a flowchart illustrating various processes and/or procedures performed by a computing entity (e.g., the computing entity of FIG. 8) as part of path length matching arms of an interferometer, in accordance with an example embodiment.

FIG. 6 provides a schematic diagram of an example system which may employ an interferometer having path length matched arms, in accordance with an example embodiment.

FIG. 7 provides a schematic diagram of an example controller of a system that employs an interferometer having path length matched arms, in accordance with an example embodiment.

FIG. 8 provides a schematic diagram of an example computing entity that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

Example embodiments provide methods for path length matching arms of an interferometer, apparatuses configured to perform such methods, computer program products configured to cause apparatuses to perform such methods, and/or the like. In various embodiments, the method includes measuring the phase noise between the two arms of the interferometer when the lengths of the arms are modified in a known manner.

For example, a length of signal guide is added to a first arm of the interferometer and the respective first phase noise measurements between the first and second arms are measured, captured, and/or determined at a plurality or a sweep of signal frequencies. The length of signal guide is then removed from the first arm and added to the second arm of the interferometer. The respective second phase noise measurements between the first and second arms are then measured, captured, and/or determined at the plurality or sweep of signal frequencies. One or more first phase noise minimum frequencies corresponding to respective minimums or nulls in the respective first phase noise measurements are identified and one or more second phase noise minimum frequencies corresponding to respective minimums or nulls in the respective second phase noise measurements are identified. The one or more first phase noise minimum frequencies and the one or more second phase noise minimum frequencies are used to determine a path length difference between the first arm and the second arm. The length of the first arm and/or the second arm may be modified based on the determined path length difference.

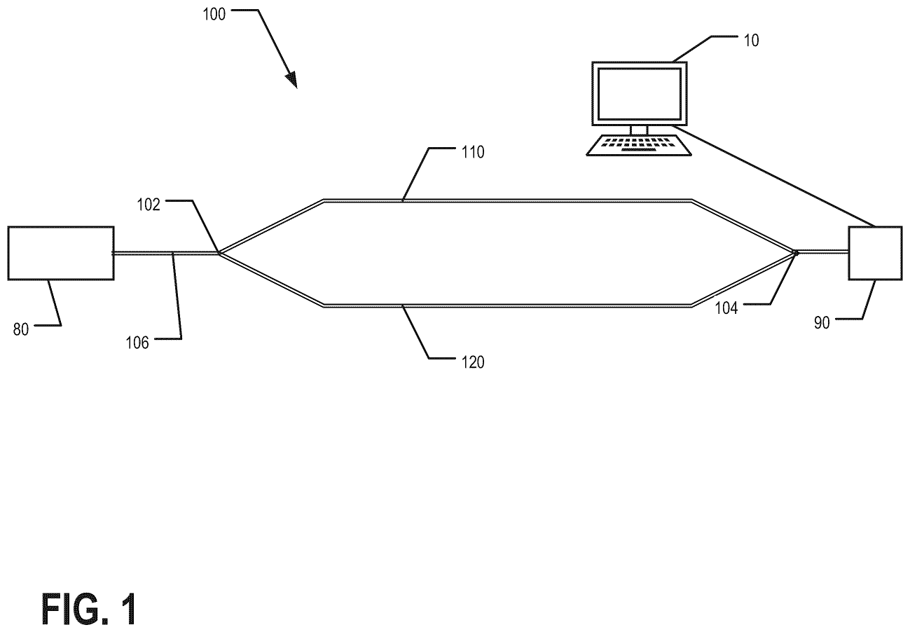

FIG. 1 provides a system for performing path length matching arms of an interferometer 100. In various embodiments, the system includes a signal sources 80. In various embodiments, the signal source 80 is an optical signal source or an electrical signal source. For example, in various embodiments, the signal source 80 is a laser or a voltage or current source (e.g., digital-analog converter (DAC), arbitrary waveform generator (AWG), and/or the like).

In various embodiments, the system includes a phase noise analyzer 90. Various phase noise analyzers are generally available for use in measuring phase noise in optical and/or electrical signals.

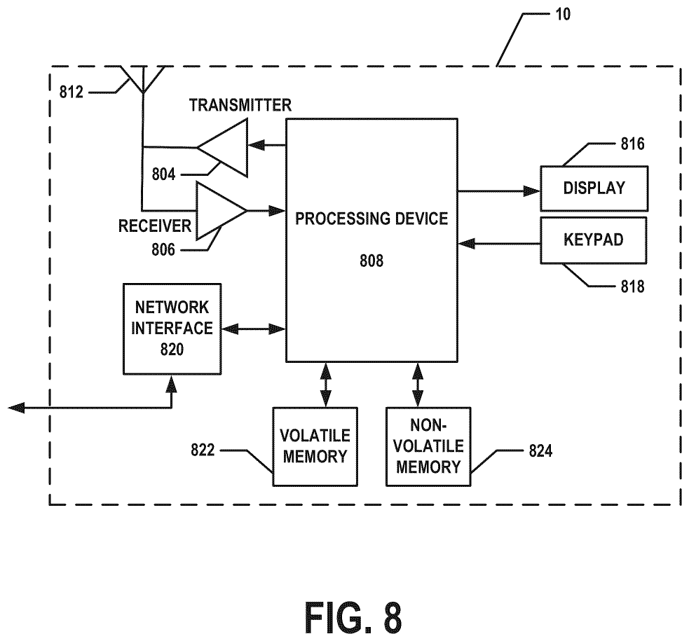

In various embodiments, a computing entity 10 is in wired and/or wireless communication with the phase noise analyzer 90. In an example embodiment, the computing entity 10 and the phase noise analyzer 90 are components of a single component of the system. In various embodiments, the computing entity 10 is configured to receive measurements (e.g., first phase noise measurements and second phase noise measurements) generated by the phase noise analyzer 90. As shown in FIG. 8 and described in more detail elsewhere herein, in various embodiments, the computing entity 10 includes a processing device 808, volatile memory 822, and non-volatile memory 824. The computing entity 10 may further include user input and/or output devices, such as display 816 and keyboard 818.

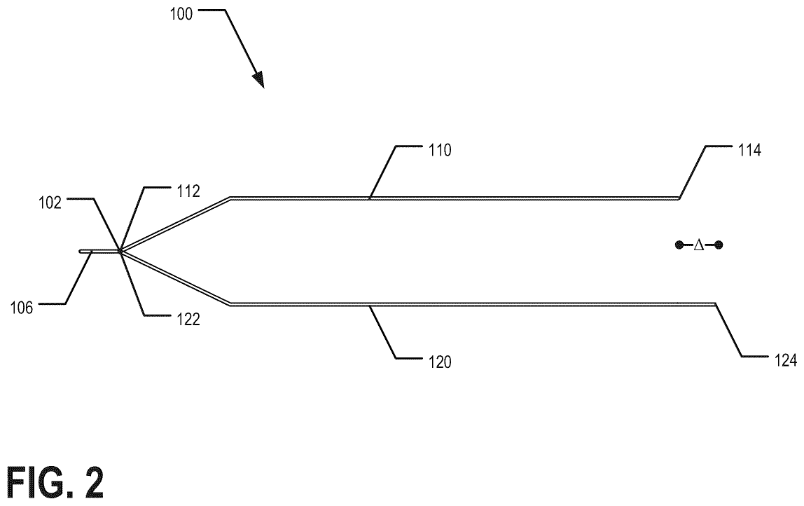

As shown in FIG. 1 and FIG. 2, the interferometer 100 includes a first arm 110 and a second arm 120. The first arm 110 and the second arm 120 begin at a beam splitter 102. For example, the interferometer includes an input guide 106 configured to be operatively coupled to an output of the signal source 80. The input guide 106 is configured to provide a signal to the beam splitter 102, which splits the signal into a first arm signal that is provided to the first arm 110 and a second arm signal that is provided to the second arm.

The first arm 110 extends a first arm length L1 from a first splitter end 112 that is operatively connected to the beam splitter 102 to a first recombination end 114 configured to be operatively connected to a beam combiner 104. The second arm 120 extends a second arm length L2 from a second splitter end 122 to a second recombination end 124 configured to be operatively connected to the beam combiner 104.

The beam combiner 104 is configured to combine the first arm signal and the second arm signal and provide the combined signal to the phase noise analyzer 90.

As shown in FIG. 2, in various instances, the first length L1 and the second length L2 may differ from one another. For example, in the illustrated embodiment, the first length L1 and the second length L2 differ from one another by a path length difference Δ. Measuring the path length difference Δ is generally impractical.

For example, not all optical fibers have the same effective index, so optical fibers of the same mechanical length may have different optical lengths. In another example, the optical path of an arm of the interferometer may include devices with unknown or poorly specified length (e.g., a fiber modulator) that may have some optical path in air, some in glass, and possibly some path in a crystal of proprietary composition, and hence refractive index, and hence of unknown optical path length, contained inside of a box. Opening the box may void the warranty or possibly destroy the unit. Such units may be installed on one arm of an interferometer, but not the other, such that one cannot depend on products having matched optical lengths in order to match the two path lengths of the arms. The arms of the interferometer may also include frequency doubling units, with zig-zag internal optical paths that again are not specified to match each other perfectly.

Similarly, electrical interferometers may have free-space parts comprising antennas or waveguides on one arm, but coaxial cable on the other, and the velocity of propagation of these different signal guides is not generally identical. Furthermore, the “phase center” of an antenna may not be located at its geometric center and might not even be at the location of the driven element. As such, determining the path length of the arms or the path length difference Δ of an interferometer is not straight forward.

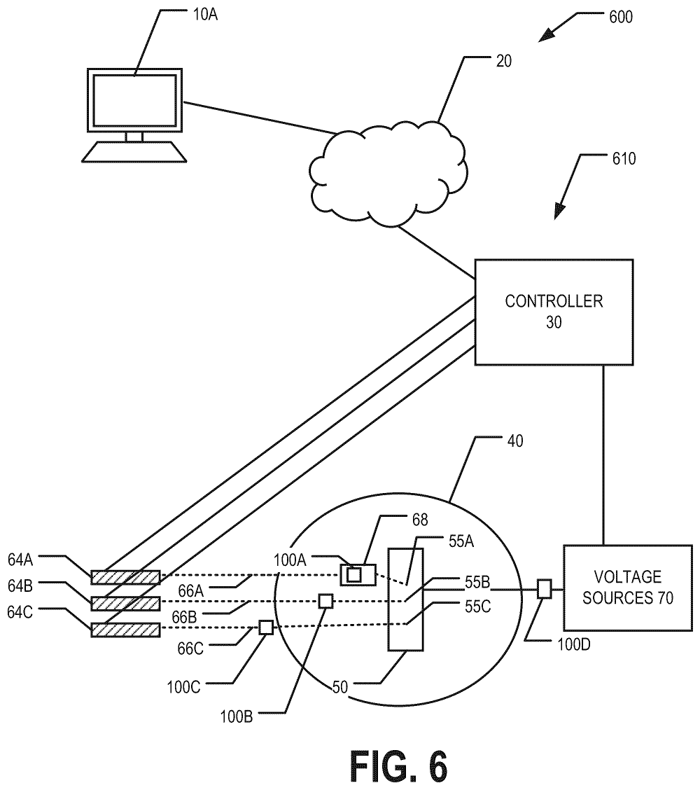

For various applications, a relatively small path length difference Δ of an interferometer can cause significant technical challenges for a system employing the interferometer. For example, the interferometer 100 may be part of a beam path system 66 (see FIG. 6) of a quantum charge-coupled device (QCCD)-based quantum computer. For example, the interferometer 100 may be part of a beam path system 66 configured to provide a gate manipulation signal or a gate laser beam to a target location of a confinement apparatus such that the gate manipulation signal or gate laser is incident on one or more qubits of the QCCD-based quantum computer to cause performance of a single qubit or two-qubit quantum logic gate. In such an application, a relatively small path length difference can result in phase noise that can cause decreased gate fidelity and have other detrimental effects in various other applications. Therefore, technical problems exist regarding providing interferometers with decreased phase noise and/or having arms with matching path lengths.

Various embodiments provide technical solutions to these technical problems. For example, various embodiments provide methods for determining a path length difference Δ between a first arm 110 and a second arm 120 of an interferometer 100. The path length of the first arm 110 and/or the second arm 120 of the interferometer 100 may then be modified based on the determined path length difference Δ so as to decrease the phase noise generated by the interferometer. Various embodiments therefore provide technical advantages to the field of interferometers and systems that employ interferometers.

For example, in an example embodiment, the interferometer 100 is an electrical interferometer. An example of an electrical interferometer is a Pound-Drever-Hall (PDH) laser frequency-phase locking apparatus. In such a system, a radio frequency (RF) modulation signal is split, and one of split copies is used to phase-modulate a beam of laser light, which is then reflected off the resonator the laser is to be locked to. The reflected beam is detected, i.e., converted back into an electrical RF signal, which may be filtered and/or amplified, and is then sent to an RF phase detector, e.g., a diode ring mixer. The other split copy of the modulation signal is sent directly to this same RF phase detector. The phase detector produces an output signal having a direct current (DC) component that is related to the phase difference between the two RF signals arriving at the phase detector, even in regions of laser frequency at which the resonator is not resonant. It may be advantageous to pass this phase detector signal through a lowpass filter to isolate the DC component of the signal. It is the paths of these two RF signals arriving at the phase detector that may be matched according to an example embodiment. Specifically, if the modulation frequency is swept over a range of values, and the DC part of the phase detector signal is plotted as a function of the modulation frequency, in general there will be a sinusoidal relationship of the DC component of the phase detector output signal vs. modulation frequency.

The PDH method of phase/frequency-locking a laser frequency to an optical reference cavity may be viewed as partially also an electrical interferometer and can serve as one platform in which to illustrate an example embodiment of the invention. In the PDH method, the optical beam is phase-modulated at a chosen frequency and the phase-modulated light is then interacted with the reference cavity. Light reflecting from the cavity is detected with a photodetector, and this detected signal is then mixed with a copy of a local oscillator signal being used to cause the phase modulation, resulting in an error signal that contains information about the frequency and/or phase difference of the incident light compared to the light resonating inside the cavity. The error signal may be used to adjust the phase or frequency of the incident beam. However, it is noted that the “detection phase”, i.e., the phase difference between the local oscillator signal delivered to the mixer and the optically detected signal at the mixer affects the amplitude of the resulting error signal in a sine-like way, with the sign of the error reversing at 180 degrees phase shift away from optimum and being nearly zero at line center 90 and 270 degrees from optimum. The amplitude of the error signal relates to its utility for the purpose of phase or frequency control. What determines this phase shift is the relative delay of the local oscillator from the point it is split from the modulation source and then conducted (e.g., through a coaxial cable to the frequency mixer) on one arm, vs. the delay of being sent from the same splitter to the phase modulator, then being carried by the light along the path to the cavity, and then reflecting from the cavity to the photodetector, and then being carried along a different cable to the frequency mixer. It is these two paths arriving at the mixer that may be matched by in an example embodiment, e.g., to make the detection phase relatively insensitive to the modulation frequency. If the paths are not matched, then the detection phase will change as the modulation frequency is changed. For example, the amplitude of the resonance signal at center of the feature will change in a sinusoidal way as frequency is changed. This mismatch may be directly measured by inserting an extra length of cable in one arm of the mixer input, e.g., in the local oscillator path, and then by sweeping the modulation frequency, mapping out the peaks and nulls of the central resonance feature of the resulting error signal. Then, that extra length is removed from the local oscillator path of the frequency mixer and inserted into the photodetector path, and then a sweep of modulation frequency is made, and the sinusoidal peaks and nulls are mapped out. From the change in the modulation frequencies at which the peaks and nulls appear in the error signal, the mismatch may be calculated. Once calculated, the mismatch may be brought to zero by suitable lengthening or shortening the electrical or optical paths in the two arms going to the frequency mixer. While it is common to employ the PDH method using a fixed modulation frequency, there may be applications in which it is advantageous to alter or sweep the modulation frequency, and having the two arms matched in length will reduce the detection phase change brought by the modulation frequency change.

Another example of an electrical interferometer comes from an attempt to measure the resonance frequency of an electrical resonator, such as a circuit, a resonant antenna, or a resonant modulator. The resonance condition may be sensed, for example, by use of a dual directional coupler that samples both the forward electrical power into the resonant element as well as the reflected power coming away from it. If these two signals are once again mixed in a frequency mixer, the low-frequency component of the resulting signal again shows the resonance in a manner similar to the PDH electro-optical method described above. The mixed signal may again be viewed as an error signal that can be used to adjust either the incident frequency or the resonance frequency of the resonant element. Once again, this system may be described as an electrical interferometer, in which a signal is split by the first directional coupler into a local oscillator path to the frequency mixer, and the resonant path that proceeds to the resonant element, reflects from it, and then arrives at the second directional coupler (i.e., which couples this reflected signal), and then from that directional coupler to the frequency mixer. Once again, if these paths are mismatched then there may be a large DC signal arising from the mismatched phase, and which may have enough amplitude to defeat use of the resonance feature to control the resonance condition. In other words, the desired resonance signal may be riding on a large-amplitude sine wave that may have more amplitude even then the resonance feature has, which will reduce the utility of the resonance feature for frequency-locking purposes. In this case it would be beneficial to match the path lengths of the two described electrical paths to the frequency mixer, and this may again be accomplished in the manner disclosed herein. Specifically, an additional length of cable is added to one path, then the frequency is swept to determine the peaks and nulls of the sinusoidal baseline, and then the extra length is removed from that path and added to the other path, and the sweep is repeated. The change in the frequencies of the peaks and nulls of the sinusoidal baseline, as a function of drive frequency, when the extra length is on one arm vs. the other arm, may be used to determine the actual path mismatch. Once the mismatch is determined, it may be brought to zero by adjustment. When so adjusted, the baseline will no longer have a sinusoidal baseline level as the drive frequency is altered, making the desired resonance signal now dominate. This facilitates use of the latter signal for the purpose of resonance control, as desired.

Thus, for a variety of types of interferometers and/or systems that may be interpreted as interferometers, various embodiments enable that matching of various arm path lengths to remove noise processes and/or undesired effects of signal modulation.

### Example Method of Path Length Matching Arms of an Interferometer

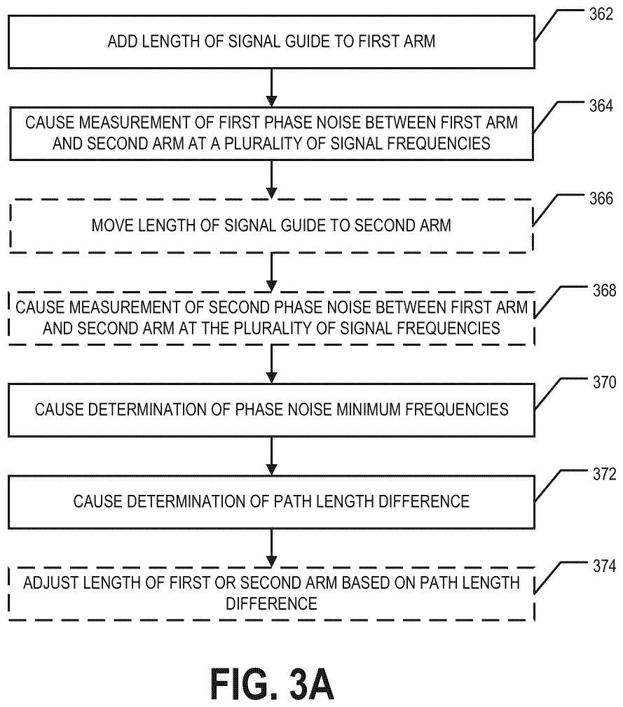

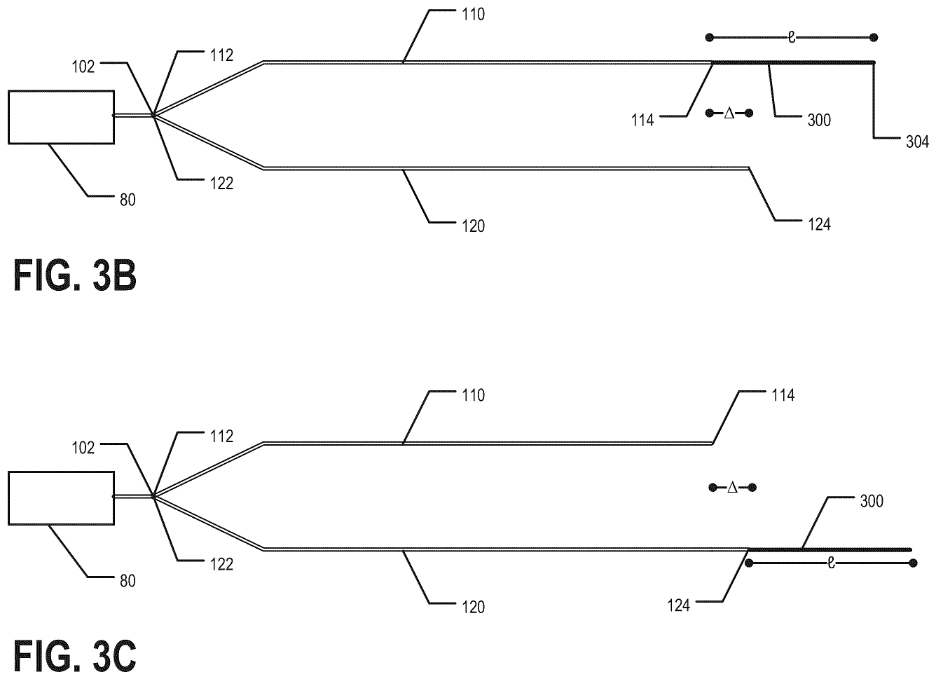

FIG. 3A provides a flowchart illustrating various processes and/or procedures for performing a method of path length matching arms of an interferometer. In various embodiments, the steps illustrated in FIG. 3A are performed by a technician.

Starting at step 362, a length of signal guide is added to or operatively connected to a first arm of the interferometer. For example, a technician may operatively connect a length of signal guide to the first arm of the interferometer. For example, as illustrated in FIG. 3B, a length of signal guide 300 may be operatively connected to the recombination end 114 of the first arm 110 of the interferometer 100.

In various embodiments, the signal guide 300 is configured to guide a signal there along. For example, in an example embodiment where the interferometer is configured for use with optical signals, the signal guide 300 is an optical fiber, waveguide, or other optical conduit or guide. In an example embodiment where the interferometer is configured for use with electrical signals (e.g., radio or microwave frequency alternating current (AC) electrical signals), the signal guide 300 is an electrical conduit such as a coaxial cable and/or a microwave waveguide.

In various embodiments, the length € of the signal guide 300 is long enough that the signal propagation time along the length (of the signal guide 300 is greater than the reciprocal of the bandwidth of the phase noise analyzer 90. For example, when the phase noise analyzer has a bandwidth B the signal propagates along the signal guide 300 at a speed v, the length [symbol] is greater than the speed v divided by the bandwidth B (e.g., [symbol] >v/B). In an example embodiment where the signal guide 300 is an optical fiber, the length [symbol] of the signal guide 300 is 20 m. In some embodiments, the length [symbol] of the signal guide 300 is long enough that the signal propagation time along the length (of the signal guide 300 is greater than the reciprocal of the bandwidth of the frequency sweep conducted and/or performed by the signal source 80.

A distal end 304 of the length of signal guide 300 and the recombination end 124 of the second arm 120 are operatively connected to the beam combiner 104, which is configured to combine the beam provided via the distal end 304 and the recombination end 124 and provide the combined signal to the phase noise analyzer 90. In an example embodiment where the interferometer is an optical interferometer, the combined signal may be provided to a photodetector configured to transduce the optical signal into an electrical signal which is then provided to the RF phase noise analyzer 90 for analysis and/or measurement. In an example embodiment, the phase noise analyzer 90 includes the photodetector.

At step 364, the phase noise between the first arm 110 and the second arm 120 is measured. For example, respective first phase noise measurements are measured, captured, and/or determined at a plurality or sweep of signal frequencies. A first phase noise measurement is the phase noise present in the combined signal with the length of signal guide 300 is operatively connected to the first arm 110 when a signal characterized by a corresponding signal frequency is propagated through the first arm 110 and the second arm 120. In various embodiments, the phase noise between the first arm 110 and the second arm 120 is measured for a plurality or sweep of signal frequencies. For example, a technician may operate the signal source 80 and/or the phase noise analyzer 90 to cause respective first phase noise measurements to be captured, measured, and/or generated for a plurality or sweep of signal frequencies.

In various embodiments, the signal source 80 is operated to cause an input signal to be provide to the interferometer 100 (e.g., via input guide 106). In an example embodiment, the input signal provided to the interferometer to, at least in part, cause the respective first phase noise measurements to be determined contains one or more frequency components that may be swept over a frequency range of interest. For example, the signal source 80 may perform and/or conduct the sweep of frequencies by altering a frequency of the input signal over a range of frequencies of interest. For example, in an example embodiment, the signal source 80 comprises an electrical signal generator and the input signal provided to the interferometer 100 is the output signal of the electrical signal generator. In such an example, the frequency sweep may be conducted by altering the frequency of the electrical signal generated by the electrical signal generator over the range of frequencies of interest.

For example, the signal source 80 is operated to provide a signal characterized by a first signal frequency. The signal is split by the beam splitter 102 and respective portions of the signal propagate along each of the first arm 110 and the second arm 120. The beam combiner combines the respective portions of the signal provided by the first arm 110 and the second arm 120 to provide a combined signal. The phase noise analyzer 90 measures the phase noise of the combined signal characterized by the first signal frequency to determine the first phase noise measurement corresponding to the first signal frequency.

The process is then repeated with the signal source 80 generating a signal characterized by a second signal frequency such that the phase noise analyzer 90 measures the phase noise of the combined signal characterized by the second signal frequency to determine the first phase noise measurement corresponding to the second signal frequency. The process repeats until the phase noise analyzer measures the respective phase noise of the combined signal for a plurality of signal frequencies to determine respective first phase noise measurements for each of the plurality of signal frequencies. In various embodiments, the plurality of signal frequencies is a sweep of frequencies in a range from several Hz (e.g., 10-100 Hz) to several MHz (e.g., 40-100 MHZ).

In some embodiments, an input signal provided to the interferometer to, at least in part, cause the respective first phase noise measurements to be determined contains a plurality of frequency components that cover a frequency range of interest. For example, the signal source 80 may provide an input signal that is (substantially) constant with respect to the frequency distribution thereof and the frequency distribution may include (non-zero) contributions from frequency components that cover the frequency range of interest. The sweep of frequencies may be performed and/or conducted by the phase noise analyzer 90 measuring different frequencies of noise present in the input signal. For example, in an example embodiment, the signal source 80 comprises an optical signal generator and the input provided to the interferometer 100 is the output signal of the optical signal generator. In such an example, the frequency sweep may be conducted by the phase noise analyzer measuring the phase noise at different frequencies present in the input signal provided to the interferometer 100.

For example, the signal source 80 is operated to provide a signal characterized by a signal frequency distribution that includes (non-zero) contributions from frequency components that cover a frequency range of interest. The signal is split by the beam splitter 102 and respective portions of the signal propagate along each of the first arm 110 and the second arm 120. The beam combiner combines the respective portions of the signal provided by the first arm 110 and the second arm 120 to provide a combined signal. The phase noise analyzer 90 measures the phase noise of the combined signal at a plurality of different frequencies within the frequency range of interest. For example, the phase noise analyzer 90 measures the phase noise of the combined signal to determine and/or measure the respective phase noise of the combined signal for a plurality of signal frequencies to determine respective first phase noise measurements for each of the plurality of frequencies (within the frequency range of interest). In various embodiments, the plurality of signal frequencies is a sweep of frequencies in a range from several Hz (e.g., 10-100 Hz) to several MHz (e.g., 40-100 MHz). For example, the frequency range of interest may be from several Hz (e.g., 10-100 Hz) to several MHz (e.g., 40-100 MHZ).

In various embodiments, the step between adjacent frequencies of the plurality of signal frequencies is logarithmic (e.g., equally spaced on logarithmic scale). In an example embodiment, the step between adjacent frequencies is a set frequency that is consistent across the range of frequencies of the plurality of signal frequencies. In an example embodiment, the step between adjacent frequencies is determined based on the frequency step and/or tunability capabilities of the signal source 80. In an example embodiment, the step between adjacent frequencies is determined based on the frequency resolution and/or settings of the phase noise analyzer 90. For example, in an example embodiment, the frequency steps and/or sampling frequencies are set by the operating system (e.g., controlling firmware and/or software) of the phase noise analyzer 90.

In various embodiments, the plurality of signal frequencies includes at least 100 frequencies. In various embodiments, the plurality of signal frequencies includes at least 1,000 frequencies. In an example embodiment, the plurality of signal frequencies includes between 1,000 and 100,000 frequencies.

In an example embodiment the phase noise analyzer provides (e.g., transmits) the respective first phase noise measurements for the plurality of frequencies to the computing entity 10. For example, for each first phase noise measurement, the phase noise analyzer 90 may provide an indication of the corresponding signal frequency and the measured phase noise. In an example embodiment, the indication of the corresponding signal frequency may be a value of signal frequency, a position of the measured phase noise in an array of first phase noise measurements, and/or the like.

At step 366, the length of signal guide 300 is disconnected and/or removed from the first arm 110 and operatively connected and/or added to the second arm 120. For example, the technician may remove the length of signal guide 300 from the first arm 110 and operatively connect the length of signal guide 300 to the second arm 120. In various embodiments, the same length of signal guide 300 is operatively connected to the second arm 120 as was operatively connected to the first arm 110 at step 362. In an example embodiment, a different length of signal guide 300 (e.g., a different piece of optical fiber, coaxial cable, or microwave waveguide) is used at step 366 than what was used at step 362.

At step 368, second phase noise measurements between the first arm 110 and the second arm 120 are measured, captured and/or determined. For example, respective second phase noise measurements are measured, captured, and/or determined at a plurality or sweep of signal frequencies. A second phase noise measurement is the phase noise present in the combined signal with the length of signal guide 300 is operatively connected to the second arm 120 when a signal characterized by a corresponding signal frequency is propagated through the first arm 110 and the second arm 120. In various embodiments, the second phase noise measurements of the phase noise between the first arm 110 and the second arm 120 are measured, captured, and/or determined for a plurality or sweep of frequencies. For example, a technician may operate the signal source 80 and/or the phase noise analyzer 90 to cause respective second phase noise measurements to be captured, measured, and/or generated for the plurality or sweep of signal frequencies.

For example, the signal source 80 is operated to provide a signal characterized by a first signal frequency. The signal is split by the beam splitter 102 and respective portions of the signal propagate along each of the first arm 110 and the second arm 120. The beam combiner combines the respective portions of the signal provided by the first arm 110 and the second arm 120 to provide a combined signal. The phase noise analyzer 90 measures the phase noise of the combined signal characterized by the first signal frequency to determine the second phase noise measurement corresponding to the first signal frequency.

The process is then repeated with the signal source 80 generating a signal characterized by a second signal frequency such that the phase noise analyzer 90 measures the phase noise of the combined signal characterized by the second signal frequency to determine the second phase noise measurement corresponding to the second signal frequency. The process repeats until the phase noise analyzer measures, captures, and/or determines the respective second phase noise measurements of the combined signal for the plurality of signal frequencies. In various embodiments, the plurality of signal frequencies is a sweep of frequencies in a range from several Hz (e.g., 10-100 Hz) to several MHz (e.g., 40-100 MHz).

In various embodiments, the step between adjacent frequencies is logarithmic (e.g., equally spaced on logarithmic scale). In an example embodiment, the step between adjacent frequencies is a set frequency that is consistent across the range of frequencies of the plurality of signal frequencies. In an example embodiment, the step between adjacent frequencies is determined based on the frequency step and/or tunability capabilities of the signal source 80. In an example embodiment, the step between adjacent frequencies is determined based on the frequency resolution and/or settings of the phase noise analyzer 90. For example, in an example embodiment, the frequency steps and/or sampling frequencies are set by the operating system (e.g., controlling firmware and/or software) of the phase noise analyzer 90.

In various embodiments, the plurality of signal frequencies includes at least 100 frequencies. In various embodiments, the plurality of signal frequencies includes at least 1,000 frequencies. In an example embodiment, the plurality of signal frequencies includes between 1,000 and 100,000 frequencies.

In various embodiments, the respective second phase noise measurements are measured, captured, and/or determined for the same plurality of signal frequencies as the respective first phase noise measurements. In an example embodiment, the respective second phase noise measurements are measured, captured, and/or determined for a different plurality of signal frequencies than the respective first phase noise measurements, but with an overlapping range of signal frequencies.

In an example embodiment the phase noise analyzer 90 provides (e.g., transmits) the respective second phase noise measurements for the plurality of frequencies to the computing entity 10. For example, for each second phase noise measurement, the phase noise analyzer 90 may provide an indication of the corresponding signal frequency and the measured phase noise. In an example embodiment, the indication of the corresponding signal frequency may be a value of signal frequency, a position of the measured phase noise in an array of second phase noise measurements, and/or the like.

In an example embodiment, the optical length (of the length of signal guide 300 is known to a sufficient level of accuracy. In such an embodiment, steps 366 and 368 may not be performed. For example, the process may proceed from step 364 to step 370.

At step 370, one or more phase noise minimum frequencies are determined. For example, the technician may cause the computing entity 10 to determine one or more signal frequencies corresponding to minimums or nulls in the first phase noise measurements and to label and/or provide the one or more signal frequencies as first phase noise minimum frequencies. For example, the technician may cause the computing entity 10 to determine one or more signal frequencies corresponding to minimums or nulls in the second phase noise measurements and to label and/or provide the one or more signal frequencies as second phase noise minimum frequencies. In various embodiments, the one or more phase noise minimum frequencies are determined in pairs with each pair including a signal frequency corresponding to minimum of the first phase noise measurements and a signal frequency corresponding to a minimum of the second phase noise measurements that corresponding to the minimum of the first phase noise measurements (e.g., is of the same order/harmonic).

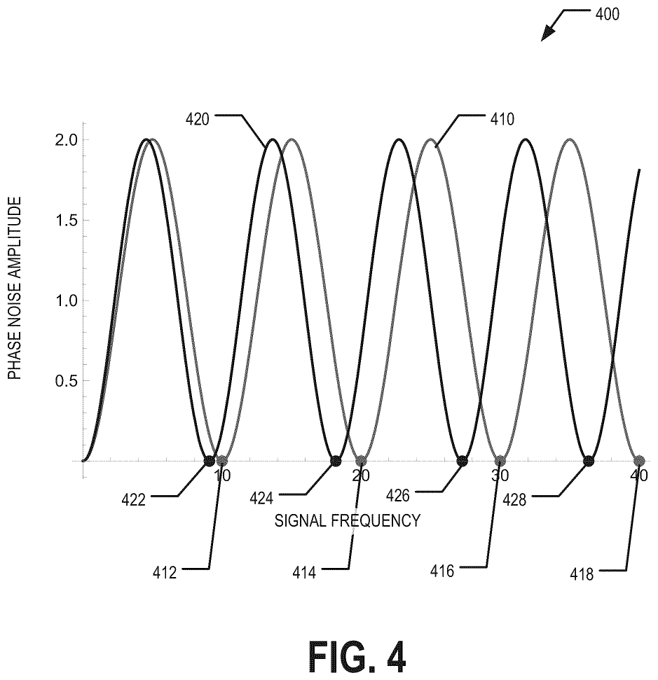

For example, FIG. 4 provides an example plot 400 that illustrates a measured amplitude of the phase noise with respect to signal frequency for the first phase noise measurements 410 and the second phase noise measurements 420. As can be seen in the plot 400, the first phase noise measurements 410 exhibit and/or include minimums and/or nulls at a first primary minimum 412, and first higher order minimums (e.g., second order minimum 414, third order minimum 416, and fourth order minimum 418). The first higher order minimums are respective harmonics of the first primary minimum 412. The second phase noise measurements 420 exhibit and/or include minimum and/or nulls at a second primary minimum 422, and second higher order minimums (e.g., second order minimum 424, third order minimum 426, and fourth order minimum 428). The second higher order minimums are respective harmonics of the second primary minimum 422.

The plot 400 illustrates the case where the first arm is shorter than the second arm of the interferometer, as with the interferometer 100 illustrated in FIG. 2. For example, the first primary minimum 412 is at a higher frequency than the second primary minimum 422. However, in various embodiments, the second arm of the interferometer may be shorter than the first arm interferometer such that the first primary minimum 412 is at a lower frequency than the first primary minimum 412.

Various minimum identification methods and/or algorithms (e.g., Newton's method, golden section search, gradient descent, and/or the like) may be used in various embodiments, to identify and/or determine the first primary minimum 412 and/or one or more first higher order minimums and to identify and/or determine the second primary minimum 422 and/or one or more second higher order minimums.

In an example embodiment, the first primary minimum 412 and the second primary minimum 422 are identified and/or determined. For example, in an example embodiment, a first phase noise minimum frequency is determined to be the first primary minimum 412 and a second phase noise minimum frequency is determined to be the second primary minimum 422.

In an example embodiment, one or more first higher order minimums (e.g., second order minimum 414, third order minimum 416, and fourth order minimum 418) are identified. One or more estimates of the first primary minimum 412 are determined based on the one or more first higher order minimums based on the knowledge that the first higher order minimums are harmonics of the first primary minimum 412 (e.g., the frequency value of the second order minimum 414 is two times that of the first primary minimum 412, the frequency value of the third order minimum 416 is three times that of the first primary minimum 412, the fourth order minimum 418 is four times that of the first primary minimum 412). An average (or weighted average) of the approximations of the first primary minimum determined based on the one or more higher order minimums may be used to determine a frequency value for the first primary minimum 412. In an example embodiment, the average (or weighted average) also includes an identified and/or determined frequency value for the first primary minimum value 412. In an example embodiment, the first phase noise minimum frequency is determined to be the average (or weighted average) of the approximations of the frequency value for the first primary minimum 412 determined based on the one or more first higher order minimums (and possibly the first primary minimum). Similarly, respective approximations of the second primary minimum may be determined based on one or more second higher order minimums and an average (or weighted average) thereof may be determined. The average (or weighted average) may include the identified and/or determined frequency value for the second primary value 422. In an example embodiment, the second phase noise minimum frequency is determined to be the average (or weighted average) of the approximations of the frequency value for the second primary minimum 422.

In an example embodiment, a plurality of pairs of first phase noise minimum frequencies and a plurality of second phase noise minimum frequencies are determined. For example, the first primary minimum 412 and the second primary minimum 414 may be used as one pair of plurality of pairs of first phase noise minimum frequencies and a plurality of second phase noise minimum frequencies. For example, the second order minimum 414 of the first phase noise measurements and a second order minimum 424 of the second phase noise measurements may be used as one pair of plurality of pairs of first phase noise minimum frequencies and a plurality of second phase noise minimum frequencies. For example, the third order minimum 416 of the first phase noise measurements and a third order minimum 426 of the second phase noise measurements may be used as another pair of plurality of pairs of first phase noise minimum frequencies and a plurality of second phase noise minimum frequencies. In another example, the fourth order minimum 418 of the first phase noise measurements and a fourth order minimum 428 of the second phase noise measurements may be used as another pair of plurality of pairs of first phase noise minimum frequencies and a plurality of second phase noise minimum frequencies, and so on, as appropriate for the application and/or the captured phase noise measurements.

At step 372, the path length difference Δ is determined. For example, the technician may determine the path length difference Δ based on the one or more pairs of phase noise minimum frequencies provided by the computing entity 10. In another example, the technician may cause the computing entity 10 to determine the path length difference Δ based on the one or more pairs of phase noise minimum frequencies. In an example embodiment, the computing entity 10 automatically determines the path length difference Δ based on the one or more pairs of phase noise minimum frequencies in response to determining the one or more pairs of phase noise minimum frequencies.

For example, when the length of signal guide 300 is attached to the longer of the two arms (corresponding to the lower frequency phase noise minimum frequency of a respective pair of phase noise minimum frequencies), the total mismatch between the two arms is the sum of the arm difference Δ and the length [symbol] of the signal guide 300 (e.g., A+€). When the length of the signal guide 300 is attached to the shorter of the two arms (corresponding to the higher frequency phase noise minimum frequency of a respective pair of phase noise minimum frequencies), the total mismatch between the two arms is the difference between the length [symbol] of the signal guide 300 and the path length difference Δ (e.g., [symbol] −Δ). The difference in the total mismatch between the two arms when the length of signal guide 300 is attached to one arm and then to the other arm results in the difference in the phase noise minimum frequencies between the first phase noise measurements and the second phase noise measurements. For example, the smaller the difference between the first primary minimum 412 and the second primary minimum 422, the smaller the path length difference Δ is.

For the lower frequency phase noise minimum frequency f₁ of a respective pair of phase noise minimum frequencies, the lower frequency phase noise minimum f₁ is equal to the reciprocal of the total mismatch when the length of signal guide 300 is operatively connected to the longer arm

$$( e . g . , {f}_{l} = \frac{1}{ℓ + Δ} ) .$$

For the higher frequency phase noise minimum frequency fₕ of a respective pair of phase noise minimum frequencies, the higher frequency phase noise minimum fₕ is equal to the reciprocal of the total mismatch when the length of signal guide 300 is operatively connected to the shorter arm

$$( e . g . , {f}_{h} = \frac{1}{ℓ + Δ} ) .$$

Solving this pair of equations for the length [symbol] and the path length difference Δ provides

$$ℓ = v \frac{{f}_{l} + {f}_{h}}{2 {f}_{l} {f}_{h}} and Δ = v \frac{{f}_{l} - {f}_{h}}{2 {f}_{l} {f}_{h}} ,$$

where v is the speed of the signal propagating along the signal guide. In an example embodiment where the signal is an optical signal and the signal guide is an optical fiber, the speed v is the speed of light divided by the refractive index of the optical fiber. In an example embodiment, where the length [symbol] is more accurately known that the speed v,

$$Δ = ℓ \frac{{f}_{l} - {f}_{h}}{{f}_{l} - {f}_{h}} .$$

Therefore, the path length difference Δ are determined at least in part based on a pair of phase noise minimum frequencies.

In an example embodiment where a plurality of pairs of phase noise minimum frequencies are determined, a plurality of path length difference estimates may be determined. For example, for each pair of phase noise minimum frequencies of the plurality of pairs of phase noise minimum frequencies, an path length difference estimate may be determined based on

$$Δ = v \frac{{f}_{l} - {f}_{h}}{2 {f}_{l} {f}_{h}} and / or Δ = ℓ \frac{{f}_{l} - {f}_{h}}{{f}_{l} + {f}_{h}} .$$

The plurality of path length difference estimates may then be averaged to determine the path length difference Δ.

In an example embodiment where the computing entity 10 determines the path length difference Δ, the computing entity 10 may provide the path length difference Δ via user perceivable manner. For example, the path length difference Δ may be displayed via display 816 or audibly provided via a speaker coupled to the processing device 808.

At step 374, the length of the first arm 110 or the second arm 120 may be adjusted based on the path length difference Δ. For example, the technician may add a portion of signal guide that has a length equal to the path length difference Δ to the shorter of the two arms of the interferometer to cause the two arms to have substantially the same path length. In an example embodiment, the technician may shorten the longer of the two arms by the path length difference Δ to cause the two arms to have substantially the same path length. For example, the technician may remove a portion of the longer of the two arms to cause the two arms to have substantially the same path length.

In various embodiments, steps 362-374 may be repeated one or more multiple times to confirm the improvement in the arm length matching of the arms of the interferometer and/or to further improve the arm length matching of the arms of the interferometer.

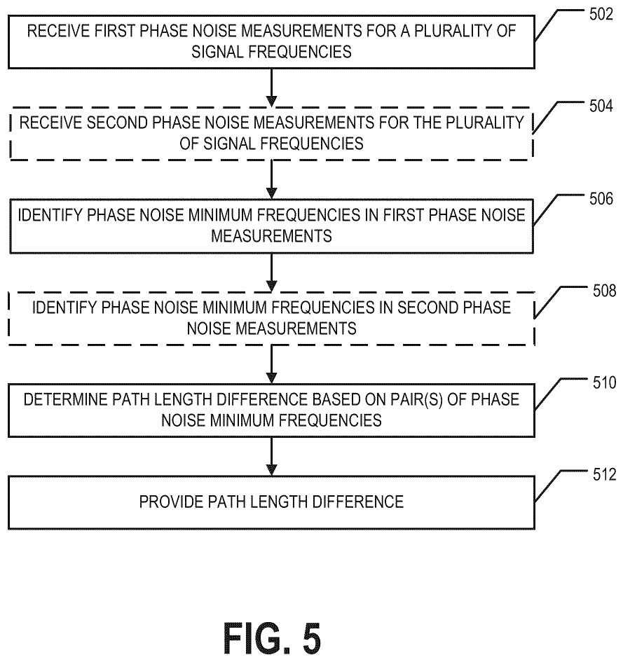

FIG. 5 provides a flowchart illustrating processes and/or procedures performed by a computing entity 10 to perform path length matching of arms of an interferometer, in accordance with various embodiments. For example, the computing entity 10 may store program code and/or computer executable instructions (e.g., in memory 822, 824). When the program code and/or computer executable instructions are executed by the processing device 808 of the computing entity 10, the computing entity 10 performs the steps of the flowchart provided by FIG. 5, in an example embodiment.

Starting at step 502, the computing entity 10 receives first phase noise measurements for a plurality of signal frequencies. For example, the phase noise analyzer 90 captured, determines, and/or measures the phase noise between the first arm 110 and the second arm 120 of the interferometer while a length of the signal guide 300 is operatively connected to the first arm 110. The phase noise measurements are captured and/or determined for a plurality of signal frequencies to generate and/or determine the first phase noise measurements. The phase noise analyzer 90 provides (e.g., transmits) the first phase noise measurements such that the computing entity 10 receives the first phase noise measurements (e.g., via receiver 806 and/or network interface 820). In an example embodiment, the first phase noise measurements include a first array of phase noise measurements with each phase noise measurement corresponding to a respective signal frequency.

At step 504, the computing entity 10 receives second phase noise measurements for the plurality of signal frequencies. For example, the phase noise analyzer 90 captured, determines, and/or measures the phase noise between the first arm 110 and the second arm 120 of the interferometer while a length of the signal guide 300 is operatively connected to the second arm 120. The phase noise measurements are captured and/or determined for a plurality of signal frequencies to generate and/or determine the second phase noise measurements. The phase noise analyzer 90 provides (e.g., transmits) the second phase noise measurements such that the computing entity 10 receives the second phase noise measurements (e.g., via receiver 806 and/or network interface 820). In an example embodiment, the second phase noise measurements include a second array of phase noise measurements with each phase noise measurement corresponding to a respective signal frequency.

In an example embodiment, the optical length e of the length of signal guide 300 is known to a sufficient level of accuracy. In such an embodiment, step 504 may not be performed. For example, the process may proceed from step 502 to step 506.

At step 506, the computing entity 10 processes the first array of phase noise measurements to determine and/or identify one or more phase noise minimum frequencies based on the first phase noise measurements. For example, the computing entity 10 may identify and/or determine the frequency values corresponding to one or more minimums in the phase noise measurements of the first phase noise measurements, and, based on the determined frequency values, the computing entity 10 identifies and/or determines one or more first phase noise minimum frequencies, similar to as described above with respect to step 370.

At step 508, the computing entity 10 processes the second array of phase noise measurements to determine and/or identify one or more phase noise minimum frequencies based on the second phase noise measurements. For example, the computing entity 10 may identify and/or determine the frequency values corresponding to one or more minimums in the phase noise measurements of the second phase noise measurements, and, based on the determined frequency values, the computing entity 10 identifies and/or determines one or more second phase noise minimum frequencies, similar to as described above with respect to step 370.

Pairs of phase noise minimum frequencies are formed by pairing respective first phase noise minimum frequencies with corresponding second phase noise minimum frequencies.

At step 510, the computing entity 10 determines the path length difference Δ based on one or more pairs of phase noise minimum frequencies. For example, similar to step 372, the computing entity 10 may use an algorithm and/or function configured to evaluate

$$Δ = v \frac{{f}_{l} - {f}_{h}}{2 {f}_{l} {f}_{h}} and / or Δ = ℓ \frac{{f}_{l} - {f}_{h}}{{f}_{l} + {f}_{h}}$$

for one or more pairs of phase noise minimum frequencies. In an example embodiment, the computing entity 10 uses an algorithm and/or function configured to evaluate

$$Δ = v \frac{{f}_{l} - {f}_{h}}{2 {f}_{l} {f}_{h}} and / or Δ = ℓ \frac{{f}_{l} - {f}_{h}}{{f}_{l} + {f}_{h}}$$

for each of a plurality of pairs of phase noise minimum frequencies to determine respective path length difference estimates. An average (or weighted average) of the path length difference estimates is determined to provide the path length difference Δ.

At step 512 the computing entity 10 provides the path length difference Δ. For example, the computing entity 10 may display the path length difference Δ via display 816. In another example, the computing entity 10 may provide the path length difference Δ audibly via a speaker. In another example, the computing entity 10 provides the path length difference Δ via a web-based portal, website, email, text message, or other form of electronic communication. For example, the path length difference Δ is provided such that a technician may adjust the length of first arm and/or the second arm based on the path length difference Δ so as to reduce the phase noise between the two arms of the interferometer.

In various embodiments, the steps of the flowchart provided by FIG. 5 may be performed in different orders than that shown in FIG. 5. For example, in an example embodiment, the steps are performed in the order of 502, 506, 504, 508, 510, 512. In various embodiments, one or more of the steps of the flowchart provided by FIG. 5 are performed in parallel. For example, in an example embodiment, steps 506 and 508 are performed in parallel.

### Example System Including a Path-Length-Matched Interferometer

In various embodiments an interferometer including arms that have been path-length-matched in accordance with an example embodiment may be incorporated into system. One example system which may employ an interferometer with path-length-matched arms is a quantum charge-coupled device (QCCD)-based quantum computer. FIG. 6 provides a schematic diagram of an example QCCD-based quantum computing system 600 that employs and/or includes interferometers 100A, 100B, 100C, and 100D that each have path-length-matched arms.

In the illustrated QCCD-based quantum computing system 600, the system 600 comprises a (classical) computing entity 10A and a quantum computer 610. The computing entity 10A may be the same or a different computing entity than the computing entity 10 used to perform the steps of FIG. 5.

In various embodiments, the quantum computer 610 comprises a controller 30, a controlled environment chamber 40 enclosing a confinement apparatus 50, one or more manipulation sources 64 (e.g., 64A, 64B, 64C), one or more voltage sources 70, one or more magnetic field generators, an optics collection system, and/or the like. In various embodiments, the controller 30 is configured to control the operation of (e.g., control one or more drivers configured to cause operation of) the manipulation sources 64, voltage sources 70, magnetic field generators, a vacuum system and/or cryogenic cooling system (not shown), and/or the like. In various embodiments, the controller 30 is configured to receive signals (e.g., electrical signals) generated and provided by one or more photodetectors of the optics collection system.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more quantum objects confined by the confinement apparatus 50. For example, a respective manipulation source 64 is configured to generate and/or provide a respective manipulation signal (e.g., an optical signal) configured to be incident one or more quantum objects located at a respective target location 55 (e.g., 55A, 55B, 55C) defined at least in part by the confinement apparatus 50.

A respective manipulation source 64 emits a respective manipulation signal and the respective manipulation signal is guided to the controlled environment chamber via a respective beam path system 66 (e.g., 66A, 66B, 66C). In various embodiments, the respective beam path system 66 is configured to cause the respective manipulation signal to be incident on the respective target location 55. In various embodiments, a respective beam path system 66 comprises a respective optical fiber, free space optics, photonic integrated circuit, and/or the like. In various embodiments, one or more of the beam path systems 66 includes an interferometer 100 (100A, 100B, 100C) having path-length-matched arms. For example, an interferometer 100 of a beam path system 66 has arms which have been path-length-matched via a method similar to that described with respect to FIGS. 3A and/or 5.

In various embodiments, an interferometer 100A, 100B is disposed within the controlled environment chamber 40. For example, the interferometer 100A is disposed on and/or part of a photonic integrated circuit 68 that is disposed and/or mounted/secured within the controlled environment chamber 40. In the illustrated embodiment, an interferometer 100C is disposed outside of the controlled environment chamber. In various embodiments, the manipulation sources 64, active components of the beam path systems 66, photonic integrated circuit 68, interferometers 100 and/or other components of the quantum computer 610 are controlled by the controller 30.

In various embodiments, the confinement apparatus 50 is an ion trap, such as a surface ion trap, Paul ion trap, and/or the like. In various embodiments, the confinement apparatus 50 is an optical trap, magnetic trap, and/or other confinement apparatus configured to confine quantum objects. In various embodiments, the quantum objects are neutral or ionic atoms; neutral, ionic, or multipolar molecules; quantum dots; and/or other quantum particles.

In various embodiments, the quantum computer 610 comprises one or more voltage sources 70. For example, the voltage sources may be arbitrary wave generators (AWG), digital analog converters (DACs), and/or other voltage signal generators. For example, the voltage sources 70 may comprise a plurality of control voltage drivers and/or voltage sources and/or at least one RF driver and/or voltage source. The voltage sources 70 may be electrically coupled to the corresponding potential generating elements (e.g., control electrodes and/or RF electrodes, and/or the like) of the confinement apparatus 50, in an example embodiment. In various embodiments, the electrical coupling of a voltage source 70 to a corresponding potential generating element includes an interferometer 100D having path-length-matched arms. In various embodiments, the controller 30 is configured to control operation of the one or more voltage sources 70.

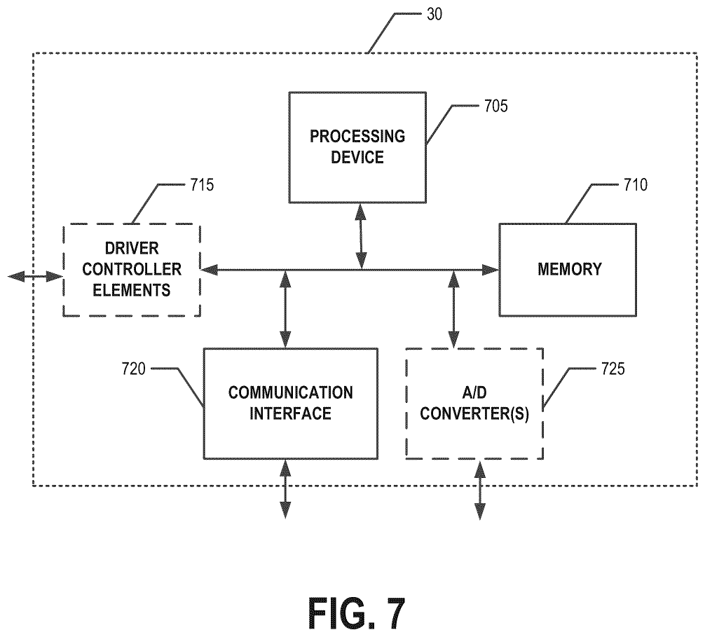

In various embodiments, the quantum computer 610 comprises an optics collection system configured to collect and/or detect photons (e.g., stimulated emission and/or fluorescence) generated by quantum objects confined by the confinement apparatus 50 (e.g., during qubit reading procedures). The optics collection system may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits (e.g., quantum objects) of the quantum computer 610. In various embodiments, the photodetectors may be in electronic communication with the quantum computer controller 30 via one or more A/D converters 725 (see FIG. 7) and/or the like. In an example embodiment, the photodetectors are disposed inside the controlled environment chamber 40. In an example embodiment, the photodetectors are disposed outside the controlled environment chamber 40 and photons collected by the optical collection system are provided to the photodetectors via a collection optics system.

In various embodiments, a computing entity 10A is configured to allow a user to provide input to the quantum computer 610 (e.g., via a user interface of the computing entity 10A) and receive, view, and/or the like output from the quantum computer 610. The computing entity 10A may be in communication with the controller 30 of the quantum computer 610 via one or more wired or wireless networks 20 and/or via direct wired and/or wireless communications. In an example embodiment, the computing entity 10A may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control operation of the voltage sources 70, magnetic field generators, cryogenic system and/or vacuum system controlling the temperature and pressure within the controlled environment chamber 40 (and/or other systems configured to control the environment within the controlled environment chamber 40), manipulation sources 64, so as to manipulate and/or cause a controlled evolution of quantum states of one or more quantum objects confined by the confinement apparatus 50, and/or read and/or detect a quantum (e.g., qubit) state of one or more quantum objects confined by the confinement apparatus. For example, the controller 30 may cause a controlled evolution of quantum states of one or more quantum objects within the confinement apparatus to execute a quantum circuit and/or algorithm. For example, the controller 30 may read and/or detect quantum states of one or more quantum objects within the confinement apparatus 50 at one or more points during the execution of a quantum circuit. In various embodiments, the quantum objects confined by the confinement apparatus 50 are used as qubits of the quantum computer 610.

### Technical Advantages

Generally, an interferometer includes a first arm and a second arm. Signals provided by the first arm are combined with signal provided by the second arm via a beam combiner to provide a combined signal. When the path lengths of the first arm and second arm are not the same, the combined signal includes phase noise. For some applications, a relatively small path length difference between the first arm and the second arm of the interferometer can cause significant technical challenges for a system employing the interferometer. For example, the interferometer 100 may be part of a beam path system 66 of a QCCD-based quantum computer. For example, the interferometer 100 may be part of a beam path system 66 configured to provide a gate manipulation signal or a gate laser beam to a target location of a confinement apparatus such that the gate manipulation signal or gate laser is incident on one or more qubits of the QCCD-based quantum computer to cause performance of a single qubit or two-qubit quantum logic gate. In such an application, a relatively small path length difference between the first arm and the second arm of the interferometer can result in phase noise that can cause decreased gate fidelity and have other detrimental effects in various other applications. Therefore, technical problems exist regarding providing interferometers with decreased phase noise and/or having arms with matching path lengths.

Various embodiments provide technical solutions to these technical problems. For example, various embodiments provide methods for determining a path length difference Δ between a first arm 110 and a second arm 120 of an interferometer 100. The path length of the first arm 110 and/or the second arm 120 of the interferometer 100 may then be modified based on the determined path length difference Δ so as to decrease the phase noise generated by the interferometer and/or present in the combined signal. Various embodiments therefore provide technical advantages to the field of interferometers and systems that employ interferometers.

### Example Controller

In various embodiments, a confinement apparatus 50 disposed within a controlled environment chamber 40 is incorporated into a quantum computer 610 or other system 600. In various embodiments, a quantum computer 610 or other system 600 further comprises a controller 30 configured to control various elements of the quantum computer 610 or other system 600. For example, the controller 30 may be configured to control the voltage sources 70; a cryogenic system, vacuum system, and/or other environmental control system controlling the environment within the controlled environment chamber 40; manipulation sources 64 (e.g., 64A, 64B, 64C); magnetic field generators; active components of beam path systems 66; and/or the like to manipulate and/or cause a controlled evolution of quantum states of one or more quantum objects confined by the confinement apparatus 50, and/or read and/or detect a quantum state of one or more quantum objects within the confinement apparatus 50.

As shown in FIG. 7, in various embodiments, the controller 30 may comprise various controller elements including processing device 705, memory 710, driver controller elements 715, a communication interface 720, analog-digital converter elements 725, and/or the like. For example, the processing device 705 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 705 of the controller 30 comprises a clock and/or is in communication with a clock.

For example, the memory 710 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 710 (e.g., by a processing device 705) causes the controller 30 to perform one or more steps, operations, processes, procedures and/or the like described herein for controlling one or more components of the quantum computer 610 (e.g., voltages sources 70, manipulation sources 64, magnetic field generators, and/or the like) to cause a controlled evolution of quantum states of one or more quantum objects, detect and/or read the quantum state of one or more quantum objects, and/or the like or components of another system employing an interferometer with path-length-matched arms.

In various embodiments, the driver controller elements 715 may include one or more drivers and/or controller elements each configured to control one or more drivers. In various embodiments, the driver controller elements 715 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 705). In various embodiments, the driver controller elements 715 may enable the controller 30 to operate a manipulation source 64. In various embodiments, the drivers may be laser drivers; vacuum component drivers; drivers for controlling the flow of current and/or voltage applied to longitudinal, RF, and/or other electrodes used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the potential generating elements of the confinement apparatus 50 (e.g., control electrodes and/or RF electrodes). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like). For example, the controller 30 may comprise one or more analog-digital converter elements 725 configured to receive signals from one or more detectors, optical receiver components, calibration sensors, photodetectors of an optics collection system, and/or the like.

In various embodiments, the controller 30 may comprise a communication interface 720 for interfacing and/or communicating with a computing entity 10. For example, the controller 30 may comprise a communication interface 720 for receiving executable instructions, command sets, and/or the like from the computing entity 10 and providing output received from the quantum computer 610 (e.g., from an optical collection system comprising one or more photodetectors) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

FIG. 8 provides an illustrative schematic representative of an example computing entity 10 that can be used in conjunction with embodiments of the present invention. In various embodiments, the computing entity 10 is configured to receive first phase noise measurements and second phase noise measurements corresponding to an interferometer, and to determine and provide a path length difference corresponding to the interferometer based at least in part on the first phase noise measurements and the second phase noise measurements. In various embodiments, a computing entity 10 is configured to allow a user to provide input to the quantum computer 610 (e.g., via a user interface of the computing entity 10) and receive, display, analyze, and/or the like output from the quantum computer 610.

As shown in FIG. 8, a computing entity 10 can include an antenna 812, a transmitter 804 (e.g., radio), a receiver 806 (e.g., radio), and a processing device 808 that provides signals to and receives signals from the transmitter 804 and receiver 806, respectively. The signals provided to and received from the transmitter 804 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 comprises a network interface 820 configured to communicate via one or more wired and/or wireless networks 20. The computing entity 10 may use a variety of communication standards and protocols to communicate with the phase noise analyzer 90 (e.g., to receive the first phase noise measurements and the second phase noise measurements) in various embodiments.

In various embodiments, the processing device 808 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In various embodiments, the processing device 808 is configured to execute program code and/or computer executable instructions stored in memory 822, 824.

The computing entity 10 may also comprise a user interface device comprising one or more user input/output interfaces (e.g., a display 816 and/or speaker/speaker driver coupled to a processing device 808 and a touch screen, keyboard, mouse, and/or microphone coupled to a processing device 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
receiving first phase noise measurements, wherein the first phase noise measurements are respective measurements of phase noise between a first arm and a second arm of an interferometer for a plurality of signal frequencies when an additional length of signal guide is operationally coupled to the first arm;
identifying a first phase noise minimum frequency based on the first phase noise measurements;
determining a path length difference based at least in part on the first phase noise minimum frequency; and
providing the path length difference.

2. The method of claim 1, further comprising:
receiving second phase noise measurements, wherein the second phase noise measurements are respective measurements of phase noise between the first arm and the second arm of an interferometer for the plurality of signal frequencies when the additional length of signal guide is operationally coupled to the second arm; and
identifying a second phase noise minimum frequency based on the second phase noise measurements,
wherein the path length difference is determined based at least in part on the first phase noise minimum frequency and the second phase noise minimum frequency.

3. The method of claim 2, wherein the first phase noise measurements and the second phase noise measurements were captured by a phase noise analyzer measurement system.

4. The method of claim 2, wherein identifying the first phase noise minimum frequency comprises identifying two or more minimums in the first phase noise measurements and determining the first phase noise minimum frequency based on respective frequencies corresponding to the two or more minimums in the first phase noise measurements and identifying the second phase noise minimum frequency comprises identifying two or more minimums in the second phase noise measurements and determining the second phase noise minimum frequency based on respective frequencies corresponding to the two or more minimums in the second phase noise measurements.

5. The method of claim 4, wherein the first phase noise minimum frequency is determined based on the two or more minimums in the first phase noise measurements being harmonics of the first phase noise minimum frequency and the second phase noise minimum frequency is determined based on the two or more minimums of the second phase noise measurements being harmonics of the second phase noise minimum frequency.

6. The method of claim 2, wherein identifying the first phase noise minimum frequency comprises identifying a respective frequencies corresponding to a first plurality of minimums in the first phase noise measurements, identifying the second phase noise minimum frequency comprises identifying a respective frequencies corresponding to a second plurality of minimums in the second phase noise measurements, and determining an path length difference comprises determining a plurality of path length differences based on pairs of frequencies including a first frequency corresponding to one of the first plurality of minimums and a second frequency corresponding to one of the second plurality of minimums and determining the path length difference based on the plurality of path length differences.

7. The method of claim 1, wherein the additional length of signal guide has a length such that a time required for light to propagate along the length of the additional length of signal guide is more than a reciprocal of a bandwidth of the phase noise analyzer.

8. The method of claim 1, wherein the additional length of signal guide is one of an optical fiber, coaxial cable, or microwave waveguide.

9. The method of claim 1, wherein the path length difference is determined based on both the first phase noise minimum frequency and a known optical length of the additional length of signal guide.

10. The method of claim 1, wherein providing the path length difference comprises indicating a balancing length of signal guide and to which of the first arm or the second arm the balancing length of signal guide should be added to balance respective arm lengths of the first arm and the second arm.

11. The method of claim 1, wherein the interferometer is configured to modulate one of optical signals or electrical signals.

12. A method comprising:
operatively connecting a length of signal guide to a first arm of an interferometer, the interferometer comprising the first arm and a second arm;
causing determination of respective first phase noise measurements between the first arm and the second arm at a plurality of frequencies while the length of signal guide is operatively connected to the first arm;
removing the length of signal guide from the first arm of the interferometer;
based at least in part on the respective first phase noise measurements, causing a determination of a path length difference between the first arm and the second arm; and
adjusting a length of the first arm or adjusting a length of the second arm based at least in part on the path length difference.

13. The method of claim 12, wherein an input signal provided to the interferometer to, at least in part, cause the respective first phase noise measurements to be determined contains one or more frequency components that may be swept over a frequency range of interest.

14. The method of claim 12, wherein an input signal provided to the interferometer to, at least in part, cause the respective first phase noise measurements to be determined contains a plurality of frequency components that cover a frequency range of interest.

15. The method of claim 12, further comprising:
operatively connecting the length of signal guide to the second arm of the interferometer; and
causing determination of respective second phase noise measurements between the first arm and the second arm at a plurality of frequencies while the length of signal guide is operatively connected to the second arm,
wherein the determination of the path length difference between the first arm and the second arm is performed based at least in part on the respective first phase noise measurements and the respective second phase noise measurements.

16. The method of claim 15, wherein identifying the first phase noise minimum frequency comprises identifying respective frequencies corresponding to a first plurality of minimums in the first phase noise measurements, identifying the second phase noise minimum frequency comprises identifying a respective frequencies corresponding to a second plurality of minimums in the second phase noise measurements, and determining a path length difference comprises determining a plurality of path length differences based on pairs of frequencies including a first frequency corresponding to one of the first plurality of minimums and a second frequency corresponding to one of the second plurality of minimums and determining the path length difference based on the plurality of path length differences.

17. The method of claim 12, wherein the first phase noise measurements were captured by a phase noise analyzer measurement system.

18. The method of claim 17, wherein the additional length of signal guide has a length such that a time required for light to propagate along the length of the additional length of signal guide is more than a reciprocal of a bandwidth of the phase noise analyzer.

19. The method of claim 12, wherein the additional length of signal guide is one of an optical fiber, coaxial cable, or microwave waveguide.

20. The method of claim 12, wherein identifying the first phase noise minimum frequency comprises identifying two or more minimums in the first phase noise measurements and determining the first phase noise minimum frequency based on respective frequencies corresponding to the two or more minimums in the first phase noise measurements.

21. The method of claim 20, wherein the first phase noise minimum frequency is determined based on the two or more minimums in the first phase noise measurements being harmonics of the first phase noise minimum frequency.

22. The method of claim 12, wherein adjusting a length of the first arm or adjusting a length of the second arm based at least in part on the path length difference comprises one of (a) adding a signal guide having a length determined based on the path length difference to a shorter of the first arm and the second arm or (b) removing a portion of the longer of the first arm and the second arm having a length determined based on the path length difference.

23. The method of claim 12, wherein adjusting a length of the first arm or adjusting a length of the second arm based at least in part on the path length difference causes the first arm and the second arm to have substantially the same path length.
